(19) United States
(12) Patent Application Publication
(10) Pub. No.: US 2009/0011270 A1
(43) Pub. Date: Jan. 8, 2009

(54) Textile article for burner cover

(76) Inventor: Fu-Biau Hsu, Taipei City (TW)

Correspondence Address: REED SMITH LLP, Suite 1400, 3110 Fairview Park Drive, Falls Church, VA, 22042, US

(21) Appl. No.: 11/976,180

(22) Filed: Oct. 22, 2007

(30) Foreign Application Priority Data
Jul. 3, 2007 (TW) 096210814

(51) Int. Cl. B32B 7/00

(52) U.S. Cl. 428/606; 428/608

(57) ABSTRACT

The invention discloses a textile article for the usage of a burner cover. The textile article is weaved with a plurality of metal yarns, each of which is blended with a plurality of metal filaments or metal fibers. Particularly, the textile article comprises 100% by weight of the metal filaments.

### BACKGROUND OF THE INVENTION

1. Field of the Invention

The present invention relates generally to a textile article, more particularly, to a textile article for burner cover.

2. Description of the Prior Art

Burner, such as a hot-water boiler or a stove, can be mainly classified into atmospheric burner and pre-mixed burner. The atmospheric burner imports air by opening a valve when the fuel, such as gas, is imported, then, the fuel and the air are naturally mixed together. Afterward, the mixture of the fuel and air can be ejected from ports of a surface of the burner, and the mixture ignited by an igniter. Thus, the mixture of the fuel and air in the atmospheric burner is not very accurate and even. Furthermore, the pre-mixed burner directly imports well pre-mixed fuel and ejects the pre-mixed fuel from ports of a surface of the burner, and the mixture is ignited by the igniter. Comparing with the atmospheric burner, the pre-mixed burner can burn the fuel with more accurate and stable ratios of fuel to air, thus, the combustion is nearly complete and the emission of CO and NOx is greatly decreased. Accordingly, the pre-mixed burner is one of the advanced combustion technologies with the advantages of energy saving, environment protecting, and safe usage. Referring to FIG. 1A and FIG. 1B, FIG. 1A shows a covering shell of a pre-mixed burner of the prior art; and FIG. 1B shows the covering shell of FIG. 1A when burning. As shown in FIG. 1A and FIG. 1B, the covering shell has a tubular shape with a Wall 70 and a bottom part 72. An opening (not shown) is opposite to the bottom part 72 to allow the pre-mixed fuel to be injected into the tube from the opening along the direction L. Particularly, a surface 702 of the wall 70 contains a plurality of ports 704. When the pre-mixed fuel injected into the tube along the direction L, it can be ejected from the ports 704, and the pre-mixed fuel burnt by igniting fire on the surface 702 of the wall 70, so as to generate flame (as shown in FIG. 1B).

The pre-mixed burner can burn the fuel more efficiently and largely decrease the emission of CO and NOx. However, the probability of flash back is higher when using a pre-mixed burner because of the structure thereof. To prevent flash back, the structure of the burner have to be more complex and heavier. Therefore, a burner cover for the covering shell is developed to solve the above-mentioned problems. The burner cover is essentially porous. Thus, the flow path of the fuel ejected from the port of burner becomes more complex, and the distribution of the fuel is more even. When a burner cover is used to cover the surface 702 of the covering shell 7 in FIG. 1A, the combustion time of fuel is greatly increased, and heat efficiency of the burner is increased.

The simplest burner cover is a metal mesh burner cover for increasing the flow path of the fuel in the burner. However, this kind of burner cover cannot significantly increase the heat efficiency. Furthermore, a porous ceramic cover, a burner cover formed of ceramic material with a plurality of ports, has also been disclosed in the prior art. Although the porous ceramic burner can increase combustion efficiency, the porous ceramic cover is heavy and brittle. Thus the ceramic burner is easily damaged by mechanical and temperature shocks.

Accordingly, a burner cover made of metal fiber, such as machined metal fiber, has been developed, e.g. the burner membrane made of machined metal fiber as disclosed in U.S. Pat. No. 7,053,014; and the textile fabric comprising bundles of machined metal filaments disclosed in WO 97/04152, to extend application of the above-mentioned burner cover. Please refer to FIG. 2A and FIG. 2B. FIG. 2A shows the burner membrane of U.S. Pat. No. 7,053,014; and FIG. 2B shows the burner member of FIG. 2A covered on the covering shell of FIG. 1B. As shown in FIG. 2A and FIG. 2B, the textile fabric 8 is formed by weaving a plurality of machined metal fiber bundles 80, formed of a plurality of twisted machined metal fibers with a plurality of weft element 82. Between two machined metal fiber bundles 80 and two weft elements 82, an open zone 84 is created, which is partially covered with machined metal fibers 802, extending out of the machined metal fiber bundle 80. According to the disclosure, the machined metal fibers 802 plays a key role on this application. The machined metal fibers 802 can significantly increase the covering ratio and volumnousity of the textile fabric 8, and hinder the fuel to obtain an equal flame distribution on the surface.

However, the machined metal fiber is a critical role as a bundle fiber in machined metal fiber bundles 80 and weft elements 82, or as an extending fiber (machined metal fiber 802) because the machined metal fiber 802 has a lower tensile strength, and the tensile strength of the machined metal fiber 802 is unable to improve through the disclosure of WO 97/04152. As a bundle fiber in machined metal fiber bundles 80 and weft elements 82, the lower tensile strength easily causes the bundle fiber to break in the yarn twisting process. As a result, the distribution of volumnousity along the machined metal fiber yarn is unable to control accurately, thus, the distribution of volumnousity on the textile fabric 8 is also unable to control accurately. Furthermore, the serious breakage of the bundle fiber results in decreasing the tensile strength of the textile fabric 8 and affecting the life-span of the burner.

For the pre-mixed burner, the mix ratio of the fuel and air and the ejecting pressure should be matched with the permeability of the burner cover, therefore, the permeability of the burner cover should not be too different, and in other words, the covering ratio has better being a constant and controllable. However, as an extending fiber 802, the lower tensile strength easily causes the extending fiber 802 to break when the burner is assembled and the pre-mixed gas is ejected with a high speed. Obviously, using the extending fiber 802 with the lower tensile strength to improve the covering ratio and permeability of the textile fabric 8 is very difficult and dangerous. The improvement is not scientifically reliable.

### SUMMARY OF THE INVENTION

Accordingly, the aspect of the present invention is to provide a textile article for a burner cover. Particularly, the permeability of the textile article of the invention is constant and scientifically controlled, and the mechanical strength of the metal filament is stronger than the above-mentioned metal fiber and can not be easily broken, so as to extend the life-span of the burner and maintain the permeability of the textile article.

According to the first preferred embodiment, the textile article for a burner cover of the invention is woven by a plurality of metal filament yarns; each of the metal filament yarns is formed from a plurality of twisted metal filaments, wherein the textile article includes 100% by weight of the metal filament yarns. According to the second preferred embodiment, the textile article for a burner cover of the invention is woven by a plurality of metal spun yarns, each of the metal spun yarns is formed from a plurality of twisted metal fibers, and each of the metal fibers is formed by chopping the metal filament, wherein the textile article includes 100% by weight of the metal spun yarns.

Furthermore, the permeability of the textile article of the invention can be adjusted by changing the number of filaments of the yarns, the twist rate of the yarns, the textile fabrication process, the thickness of the textile article, and the covering ratio of the textile. Moreover, the life-span of the textile article of the invention can be adjusted by changing the diameter of filaments, the number of yarns, and the twist rate of the yarns.

The objective of the present invention will no doubt become obvious to those of ordinary skill in the art after reading the following detailed description of the preferred embodiment, which is illustrated in the following figures and drawings.

### BRIEF DESCRIPTION OF THE APPENDED DRAWINGS

FIG. 1A shows a covering shell of a pre-mixed burner of the prior art.

FIG. 1B shows the covering shell of FIG. 1A when burning.

FIG. 2A shows the burner membrane of U.S. Pat. No. 7,053,014.

FIG. 2B shows the burner member of FIG. 2A covered on the covering shell of FIG. 1B.

FIG. 3A shows the textile article for a burner cover of the invention.

FIG. 3B is a cross section according to plane O-O′ of the metal filament yarn of FIG. 3A.

FIG. 4 shows the textile article for a burner cover of the invention.

FIG. 5A shows the metal spun yarns of the textile article of the invention.

FIG. 5B shows a woven textile article formed by the metal spun yarn of FIG. 5A.

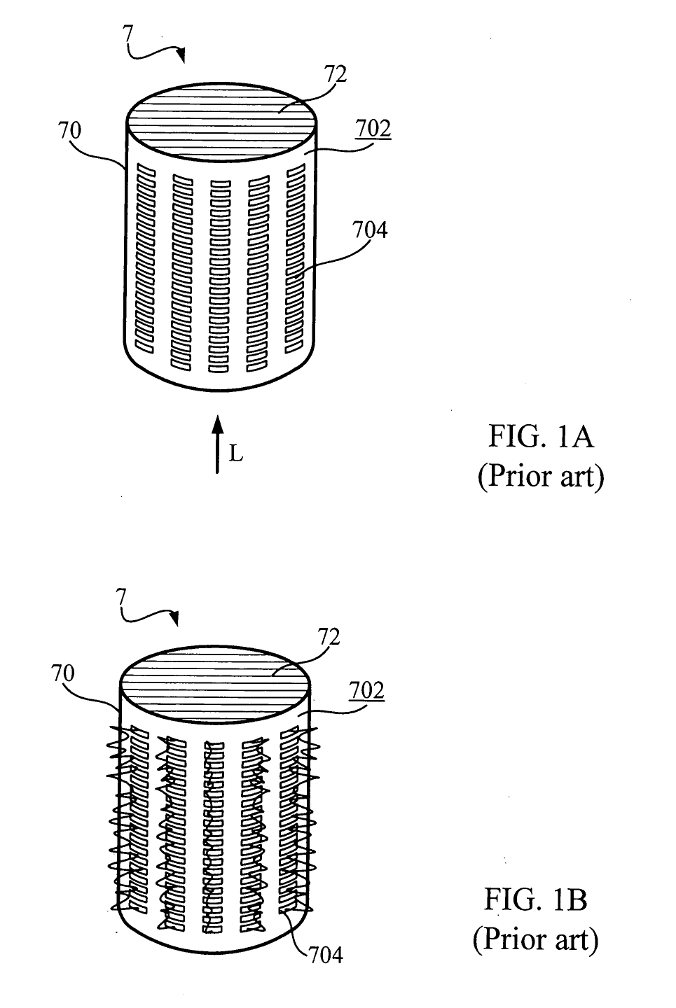

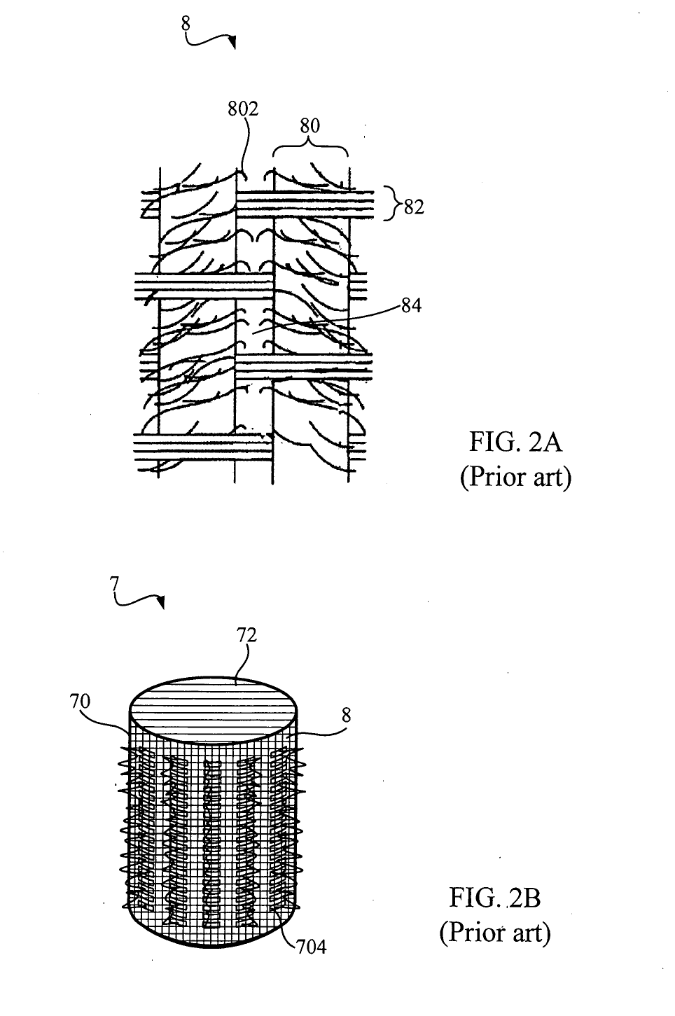

### DETAILED DESCRIPTION OF THE INVENTION

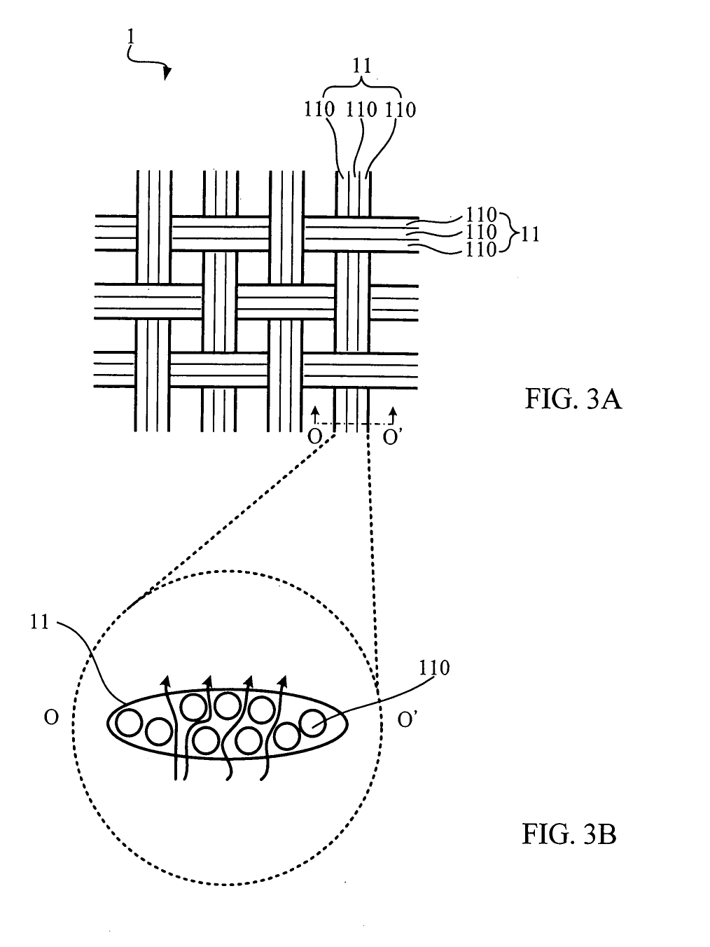

Please refer to FIG. 3A and FIG. 3B. FIG. 3A shows the textile article for a burner cover of the invention; and FIG. 3B is a cross section according to plane O-O′ of the metal filament yarn of FIG. 3A. As shown in FIG. 3A, the textile article 1 is formed by a weaving process. Particularly, the textile article 1 is woven by a plurality of metal filament yarns 11; each of the metal filament yarns 11 is formed from a plurality of twisted metal filaments 110. Furthermore, the textile article 1 includes 100% by weight of the metal filament yarns 11. In practice, the metal filament is formed by bundle drawing (see U.S. Pat. No. 3,379,000), thus, the thickness and the strength of the metal filament are able to accurately control.

As shown in FIG. 3B, the metal filament yarns 11 of the invention are formed by a plurality of twisted metal filaments 110, therefore, there are a number of filaments 110 in the cross-section of the metal filament yarn 11. Particularly, when the textile article 1 is used to make a burner cover, fuel such as gas can pass through the metal filament yarn 11 via the spaces between metal filaments 110 (see the arrows in FIG. 3B). The path shown in FIG. 3B can be longer and more complex than that of the prior art by quantitatively controlling the twist rate of the metal filament yarn 11, and there is no problem in the breakage of the metal filament. Thus, the distribution of volumnousity along the metal filament yarn 11 is uniform.

Because the metal filament is formed by bundle drawing, the number, the thickness and the strength of the metal filament can be accurately controlled. Accordingly, the permeability of the metal filament yarn 11 can be adjusted by changing the diameter, number, and strength of the metal filament 110, but not depending on the unreliable factors, such as the extending part of metal fibers. Therefore, the volume of gas fuel pass through different parts of the textile article of the invention can be approximately equal, and the heat radiation and heat efficiency provided by different parts of the textile article can also be approximately equal. Accordingly, in an embodiment, the textile article of the invention has at least one textile structure character, so that the burner cover of the invention has a substantial constant permeability.

In practice, larger diameter of the filaments results in higher allowable temperature of the textile article, therefore, the metal filament has a diameter within the range of 15 μm to 200 μm.

In practice, to decrease the dissipating rate of the gas fuel and increase the heat surface of the gas fuel, the textile structure character includes, but not limited to that the metal filament yarns 11 contain more than ten metal filaments 110.

In practice, the textile structure character includes, but not limited to, the textile article with a covering ratio of more than 50%, such as 60%, 80%, or 90%. The term “covering ratio” refers to the ratio of the area of the metal filament yarns to the area of the textile article. In the embodiment, “covering ratio” can also refer to the gap size between each warp or weft of the textile article, and the larger the covering ratio, the smaller the gap. Furthermore, higher covering ratio means the fuel can be distributed on the textile article more equally, and the textile article can provide fuel for burning in equal volume of different parts thereon.

In practice, the twist level can affect the permeability and life-span of yarns and textile article, therefore, at least one textile structure character includes, but not limited to, the metal filament yarns with a twist level of 0 to 200 twists per inch. In practice, at least one textile structure character includes, but not limited to, the metal filament yarns with a density of 15 to 1000 filaments per inch. In practice, at least one textile structure character includes, but not limited to, the textile article with a multi-layer structure, such as a double layer structure, a triple layer structure, etc.

In practice, the metal filaments can be formed by a metal material, especially a metal material that is resistant to high temperature, such as, but not limited to, stainless steel, FeCrAl alloy, NiCr alloy, CuNi alloy or FeCr alloy.

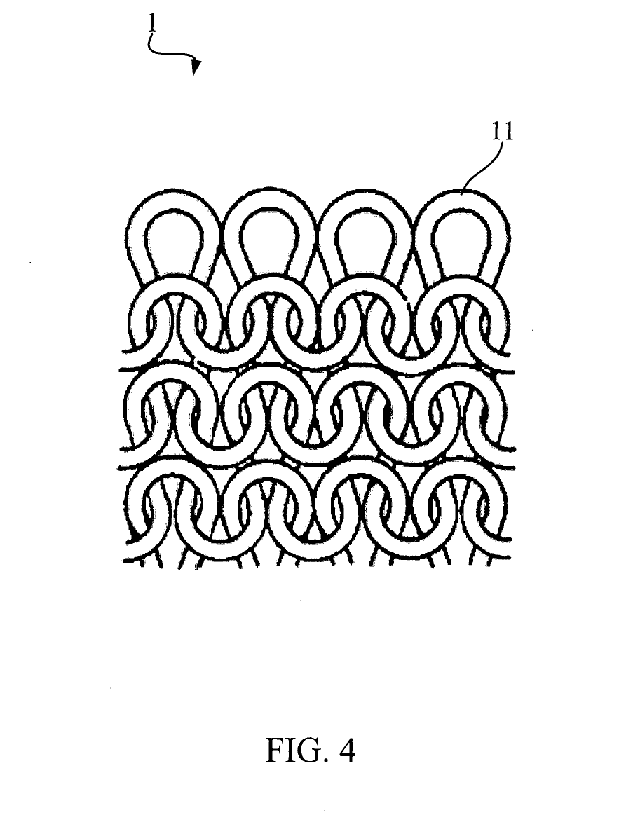

Please refer to FIG. 4, which shows the textile article for a burner cover of the invention. As shown in FIG. 4, the textile article 1 is formed by knitting a plurality of metal filament yarns 11.

In practice, the textile article of the invention can also be formed by warp knitting process, or braiding process, but not limited to the above-mentioned weaving process or knitting process.

In another embodiment, the textile article for a burner cover of the invention can be formed by weaving a plurality of metal spun yarns. Moreover, each of the metal spun yarns is formed by a plurality of twisted metal fibers, and each of the metal fibers is formed by chopping a metal filament made by bundle drawing (see U.S. Pat. No. 3,379,000). A metal spun yarn is meant a yarn obtained through a conventional textile spinning process to join a plurality of short fibers obtained by chopping a metal filament together. The short fiber has higher tensile strength and more accurate cross section. Thus, the metal spun yarn also has higher tensile strength and better distribution of volumnousity along the metal spun yarn. The textile article includes 100% by weight of the metal spun yarns.

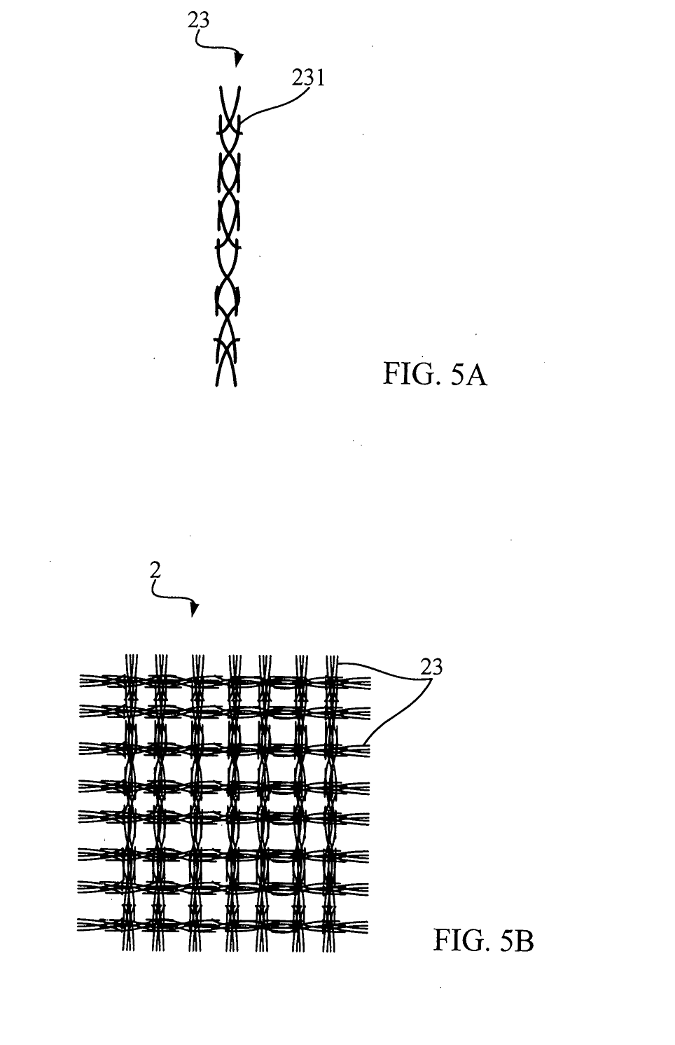

Please refer to FIG. 5A and FIG. 5B. FIG. 5A shows the metal spun yarns of the textile article of the invention; and FIG. 5B shows a woven textile article formed by the metal spun yarn of FIG. 5A. As shown in FIG. 5A, the metal spun yarn 23 is formed by a plurality of twisted metal fibers 231. Compared with the above-mentioned metal filament yarns, the metal spun yarns 23 have a larger gas fuel contactable surface area. Therefore, with equal surface area and textile structure, the textile article 2 that is formed by metal spun yarns of FIG. 5B has a higher efficiency of heat radiation than the textile article 1 which is made of metal filament yarns as seen in FIG. 3A. As a result, the textile article formed of metal spun yarns can be used to form a burner cover with space limitation.

In practice, the textile article made of the metal spun yarns can also have the above-mentioned textile structure characters, and result in the substantial constant permeability of the burner cover.

In practice, the twist level can affect the permeability of yarns and textile article, therefore, the at least one textile structure character includes, but not limited to, the metal spun yarns with a twist level of 0 to 200 twists per inch.

In practice, the at least one textile structure character includes, but not limited to, the metal spun yarns with a density of 20 to 1000 filaments per inch.

In practice, the at least one textile structure character includes, but not limited to, the textile article with a multi-layer structure, such as a double layer structure, a triple layer structure, etc.

In practice, the textile structure character includes, but not limited to, the textile article with a covering ration of more than 50%, such as 60%, 80%, or 100%.

In practice, the at least one textile structure character includes, but not limited to, the diameter of the metal fibers is approximately equal to the diameter of the above-mentioned metal filaments.

In practice, the metal spun yarns can also be woven by knitting process, warp knitting process, or braiding process, but not limited to the above-mentioned weaving or knitting processes, to form the textile article of the invention, but it is by no means limited to the weaving process of FIG. 5B.

In practice, the textile article can be applied to the burner which can be, but not limited to, a hot plate, a hot-water heater, or a drying apparatus. Particularly, the textile article of the invention can be applied to the above-mentioned pre-mixed burner.

To sum up, compared with the burner cover of the prior art, the metal filament or fiber of the textile article of the invention would not be easily broke, therefore the life-span of the burner with the textile article of the invention will not be shortened. In addition, the air permeability of the textile article of the invention can be adjusted by changing the factors, such as the number of filaments of yarns, the twist level of yarns, the textile process of the article, the thickness of the article, and the covering ratio of the article, furthermore, the life-span of the burner cover made of the textile article of the invention can be controlled by the factors such as the diameter of filaments, the number of yarns, and the twist level of yarns. Therefore, the life-span of the burner cover made of the textile article of the invention will not be easily shortened with time and the air permeability can be maintained to fit the requirement of different using situation. Particularly, the textile article of the invention can be made of woven metal spun yarns; therefore, the total surface area can be increased effectively without increasing the covering surface area, so as to fit the requirement of different burners. The burner cover made of the textile article of the invention can increase the burning efficiency of fuel, decrease the consumption of fuel, and prevent the accidents caused by the emission of CO and NOx through incompletely burning.

Although the present invention has been illustrated and described with reference to the preferred embodiment thereof, it should be understood that it is in no way limited to the details of such embodiment but is capable of numerous modifications within the scope of the appended claims.

What is claimed is:

1. A textile article for a burner cover, said textile article being woven by a plurality of metal filament yarns, each of said metal filament yarns being formed from a plurality of twisted metal filaments, wherein the textile article comprising 100% by weight of the metal filament yarns.

2. The textile article of claim 1, wherein each of the metal filaments has a diameter within the range of 15 μm to 200 μm.

3. The textile article of claim 1, wherein each of the metal filaments is a bundle drawn filament.

4. The textile article of claim 1, wherein each of the metal filaments is made of a material selected from the group consisting of: stainless steel, FeCrAl alloy, NiCr alloy, CuNi alloy and FeCr alloy.

5. The textile article of claim 1, further comprising at least one textile structure character, resulting in the burner cover with a substantial constant permeability.

6. The textile article of claim 5, wherein the at least one textile structure character comprises the metal filament yarns with a twist level of 0 to 200 twists per inch.

7. The textile article of claim 5, wherein the at least one textile structure character comprises the metal filament yarns with a density of 15 to 1000 filaments per inch.

8. The textile article of claim 5, wherein the at least one textile structure character comprises the textile article has a covering ration of more than 50%.

9. The textile article of claim 5, wherein the at least one textile structure character comprises the textile article has a multi-layer structure.

10. The textile article of claim 5, wherein the at least one textile structure character comprises metal filament yarns, each of which contains more than 10 metal filaments.

11. The textile article of claim 1, wherein the textile article is formed by a textile process which is selected from the group consisting of: a knitting process, a warp knitting process, a weaving process, and a braiding process.

12. The textile article of claim 1, wherein the burner is a pre-mixed burner.

13. A textile article for a burner cover, said textile article being woven by a plurality of metal spun yarns, each of said metal spun yarns being formed by a plurality of twisted metal fibers, and each of said metal fibers being formed by cutting a metal filament, wherein the textile article comprising 100% by weight of the metal spun yarns.

14. The textile article of claim 13, wherein each of the metal filaments has a diameter within the range of 15 μm to 200 μm.

15. The textile article of claim 13, wherein each of the metal filaments is bundle drawn filament.

16. The textile article of claim 13, wherein each of the metal filaments is made of a material selected from the group consisting of: stainless steel, FeCrAl alloy, NiCr alloy, CuNi alloy and FeCr alloy.

17. The textile article of claim 13, further comprising at least one textile structure character, resulting in the burner cover with a substantial constant permeability.

18. The textile article of claim 17, wherein the at least one textile structure character comprises the metal spun yarns with a twist level of 0 to 200 twists per inch.

19. The textile article of claim 17, wherein the at least one textile structure character comprises the metal spun yarns with a density of 15 to 1000 filaments per inch.

20. The textile article of claim 17, wherein the at least one textile structure character comprises the textile article has a covering ration of more than 50%.

21. The textile article of claim 17, wherein the at least one textile structure character comprises the textile article has a multi-layer structure.

22. The textile article of claim 13, wherein the textile article is formed by a textile process which is selected from the group consisting of: a knitting process, a warp knitting process, a weaving process, and a braiding process.

23. The textile article of claim 13, wherein the burner is a pre-mixed burner.
